(19) United States
(12) Patent Application Publication
(10) Pub. No.: US 2026/0154889 A1
(43) Pub. Date: Jun. 4, 2026

(54) METHOD AND APPARATUS FOR CONTROLLING GAIT MOTION OF CHARACTER

(71) Applicant: Korea Advanced Institute of Science and Technology, Daejeon (KR)

(72) Inventors: Junyong NOH, Daejeon (KR); Chaelin KIM, Daejeon (KR); Soo Jin CHOI, Daejeon (KR); Haekwang EOM, Daejeon (KR); Jung Eun YOO, Daejeon (KR)

(21) Appl. No.: 19/243,044

(22) Filed: Jun. 19, 2025

(30) Foreign Application Priority Data
Dec. 2, 2024 (KR) 10-2024-0176852
Mar. 20, 2025 (KR) 10-2025-0035798

(51) Int. Cl. G06T 13/40; A63F 13/57

(52) U.S. Cl. CPC G06T 13/40; A63F 13/57

(57) ABSTRACT

In accordance with a first aspect of a method for controlling a gait motion of a character performed by an apparatus for controlling a gait motion of a character, the method comprising: setting a gait feature corresponding to a gait motion of a character; and controlling the gait motion of the character based on the gait feature, wherein the gait feature includes a spatial feature and a temporal feature corresponding to the gait motion.

### CROSS REFERENCE TO RELATED APPLICATION

The present application claims priority to Korean provisional Patent Application No. 10-2024-0176852, filed on Dec. 2, 2024 and Korean Patent Application No. 10-2025-0035798, filed on Mar. 20, 2025, the entire contents of which are hereby incorporated by this reference.

### BACKGROUND OF THE INVENTION

### Field of the Invention

The present disclosure relates to a method and apparatus for controlling a gait motion of a character.

This work was supported by Korea Creative Content Agency grant funded by the Korea government (Ministry of Culture, Sports and Tourism) (Project unique No.: 2370000036; Project No.: 00228331; R&D project: Global Virtual Performance Core Technology Development; Research Project Title: Development of a universal fashion creation platform technology for expressing avatar individuality; and Project period: 2024 Jan. 1˜2024 Dec. 31)

### Description of the Related Art

Character animation is utilized in various computer graphics fields such as video games, animation, or avatars in virtual spaces. In particular, so-called locomotion motions, such as walking, running, or jumping, are essential for a character to freely move around in a virtual space or to move to a specific target point.

In order for a natural animation motion to be performed, motion capture data obtained by capturing a gait motion of a character or an actual person may be utilized. Here, the motion capture data may refer to data that quantifies movements (e.g., position or rotation, etc.) of a character or a person.

According to a conventional method of controlling a gait motion of a character, a method of assigning a text label representing a gait motion, such as walking or running, is used in order to classify gait motions. Such a method has been widely used due to the advantage that it may simply represent motions, but there exists a limitation in that, as the number of motions to be represented increases, label assignment becomes difficult, the way of assigning text labels differs for each person, and it is difficult to distinguish differences among similar motions only with text.

According to another conventional method of controlling a gait motion of a character, by setting a target foot contact position and a duration in which the foot is in contact with the ground at that foot contact position, a method of generating a gait motion by inverse kinematics (IK) is used such that foot contact occurs at a corresponding position and at a set timing. However, such a method has a problem in that real-time motion control is impossible, and unnatural motions are generated because accurate foot contact is prioritized.

According to still another conventional method of controlling a gait motion of a character, relatively more natural motions may be synthesized compared to the above-described conventional methods by utilizing motion capture data of an actual person. However, such a method has a problem in that only walking and running motions that match a given foot contact position may be synthesized, and motions of various styles may not be handled.

According to yet another conventional method of controlling a gait motion of a character, more various motions may be synthesized by considering foot contact patterns for walking, running, or jumping. In such a method, although the contact position (spatial information) is controllable, there exists a limitation in that temporal information of the motion, such as foot contact duration, is not utilized as control information.

### SUMMARY OF THE INVENTION

An object to be solved by the present disclosure includes providing a technology for controlling a gait motion of a character by considering a spatial feature and a temporal feature corresponding to the gait motion.

However, the problem to be solved by the present disclosure is not limited to that mentioned above, and other problems to be solved that are not mentioned may be clearly understood by those of ordinary skill in the art to which the present disclosure belongs from the following description.

In accordance with a first aspect of a method for controlling a gait motion of a character performed by an apparatus for controlling a gait motion of a character, the method comprising: setting a gait feature corresponding to a gait motion of a character; and controlling the gait motion of the character based on the gait feature, wherein the gait feature includes a spatial feature and a temporal feature corresponding to the gait motion.

The spatial feature may be determined based on a contact surface between a left foot sole or a right foot sole of the character and a ground, which is formed on the ground according to walking of the character.

The spatial feature may include at least one of a base width, a right step length, or a left step length. Here, based on a moving direction of the character, corresponding to a first point positioned rearmost on an n-th (n is a natural number) contact surface between the left foot sole and the ground, a second point positioned rearmost on an m-th (m is a natural number) contact surface between the right foot sole and the ground, and a third point positioned rearmost on an (n+1)-th contact surface between the left foot sole and the ground, the base width may be determined as a distance between the first point and the second point, based on a direction perpendicular to the moving direction, the right step length may be determined as a distance between the first point and the second point based on the moving direction, and the left step length may be determined as a distance between the second point and the third point based on the moving direction.

The temporal feature may include at least one of a right step time, a left step time, a right stance time, or a left stance time. Here, the right step time may be determined as a time from a contact start point between a left foot sole of the character and the ground to a contact start point between a right foot sole of the character and the ground, the left step time may be determined as a time from a contact start point between the right foot sole and the ground to a contact start point between the left foot sole and the ground, the right stance time may be determined as a contact duration between the right foot sole and the ground, and the left stance time may be determined as a contact duration between the left foot sole and the ground.

The gait motion may be controlled by further considering a pose feature including positions and velocities of respective joints of the character.

The pose feature may be calculated for each frame including the gait motion, and the gait feature may be identically set for each frame constituting a gait cycle corresponding to the gait motion.

The method may further comprise: retrieving a reference gait feature and a reference pose feature respectively corresponding to the gait feature and the pose feature, based on a plurality of reference gait features and a plurality of reference pose features extracted from a plurality of gait motions included in a pre-configured database. Here, in the controlling the gait motion, the gait motion of the character may be controlled based on the reference gait feature and the reference pose feature.

The reference gait feature may be one of the plurality of reference gait features, which is most similar to the gait feature, selected by using a pre-configured algorithm, and the reference pose feature may be one of the plurality of reference pose features, which is most similar to the pose feature, selected by using the algorithm.

In the controlling the gait motion, a current gait motion of the character may be updated to a next gait motion based on the reference gait feature and the reference pose feature.

In the controlling the gait motion, as a difference in the pose feature between the current gait motion and the next gait motion exceeds a preset value, an intermediate gait motion acquired by using a pre-configured interpolation algorithm may be applied between the current gait motion and the next gait motion to control the gait motion.

In the controlling the gait motion, as a difference in the pose feature between the current gait motion and the next gait motion exceeds a preset value, an intermediate gait motion, to which a preset ratio is applied for the difference, may be applied between the current gait motion and the next gait motion to control the gait motion.

In accordance with a second aspect of an apparatus for controlling a gait motion of a character, the apparatus comprising: a memory storing at least one instruction; and a processor executing the at least one instruction stored in the memory, wherein the at least one instruction, when executed by the processor, causes the processor to: set a gait feature corresponding to a gait motion of a character; and control the gait motion of the character based on the gait feature, wherein the gait feature includes a spatial feature and a temporal feature corresponding to the gait motion.

In accordance with a third aspect of a non-transitory computer-readable storage medium storing computer-executable instructions, the computer executable instructions, when executed by a processor, cause the processor to perform a method, the method comprising: setting a gait feature corresponding to a gait motion of a character; and controlling the gait motion of the character based on the gait feature, wherein the gait feature includes a spatial feature and a temporal feature corresponding to the gait motion.

In accordance with a fourth aspect of a computer program stored in a non-transitory computer-readable storage medium, wherein the computer program, when executed by a processor, comprises an instruction for causing the processor to perform a method, the method comprising: setting a gait feature corresponding to a gait motion of a character; and controlling the gait motion of the character based on the gait feature, wherein the gait feature includes a spatial feature and a temporal feature corresponding to the gait motion.

According to an embodiment, the gait motion of the character may be intuitively controlled through spatiotemporal parameters for a foot contact pattern. Since a numerically quantifiable and objective control method is used, interpretation does not vary depending on a user who controls the gait motion of the character, and a style corresponding to the gait motion may be defined in a continuous space.

In addition, this may be commonly applied to humanoid characters including two feet.

In addition, by controlling motions of the character through a real-time motion control algorithm, motions desired by users may be implemented in real time. In this case, transitions between motions may be naturally connected through an interpolation algorithm.

In addition, by providing a visual interface of a controller capable of controlling a gait pattern, a user may intuitively and easily control the gait motion of the character through such an interface.

In addition, an embodiment of the present disclosure may be utilized for real-time motion control simulation, and may also be utilized as a motion explorer application. That is, by using gait feature parameters, rather than a conventional text classification method, more accurate gait motion representation becomes possible, and different motions may be explored in real time according to changes in the parameters, and the exploration may be easily performed by visually presenting the motions. In addition, through the utilization of a motion control algorithm widely used in games, an embodiment of the present disclosure may be easily integrated into existing character control applications.

The effects obtainable by the present invention are not limited to those mentioned above, and other effects not explicitly stated will be clearly understood by those of ordinary skill in the art from the following description.

### BRIEF DESCRIPTION OF THE DRAWINGS

FIG. 1 is a block diagram exemplarily illustrating an apparatus for controlling a gait motion of a character according to an embodiment.

FIG. 2 is a block diagram exemplarily illustrating the function of the gait motion control program for the character.

FIG. 3 is a flowchart exemplarily illustrating a method for controlling a gait motion of a character according to an embodiment.

FIG. 4 is an exemplary diagram illustrating a spatial feature for the gait motion.

FIG. 5 is an exemplary diagram illustrating a temporal feature for the gait motion.

FIG. 6 is an exemplary diagram illustrating a pose feature, which is composed of positions and velocities of respective joints of the character.

FIG. 7 is a flowchart illustrating a method for controlling a gait motion of a character according to an embodiment.

FIG. 8 is an exemplary diagram specifically illustrating a gait feature extraction operation in the method for controlling a gait motion of a character according to the embodiment of FIG. 7.

FIG. 9 is an exemplary diagram specifically illustrating a gait motion control operation in the method for controlling a gait motion of a character according to the embodiment of FIG. 7.

FIG. 10 is an exemplary diagram illustrating that a pose of a character is controlled based on a pose feature and a gait feature.

FIG. 11 is an exemplary diagram illustrating a gait motion control interface of a character according to an embodiment.

FIGS. 12A-12B are graphs showing evaluation results on a method for controlling a gait motion of a character according to an embodiment of the present disclosure.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing embodiments of the present invention, if it is considered that a detailed description of a known function or configuration may unnecessarily obscure the gist of the present invention, the detailed description will be omitted. In addition, the terms described below are terms defined in consideration of functions in the embodiments of the present invention, the terms may vary according to the intention or precedent of a technician working in the field, the emergence of new technologies, and the like. Therefore, the terms used in the present disclosure should be defined based on the meaning of the terms and the overall contents of the present disclosure, not just the name of the terms.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure.

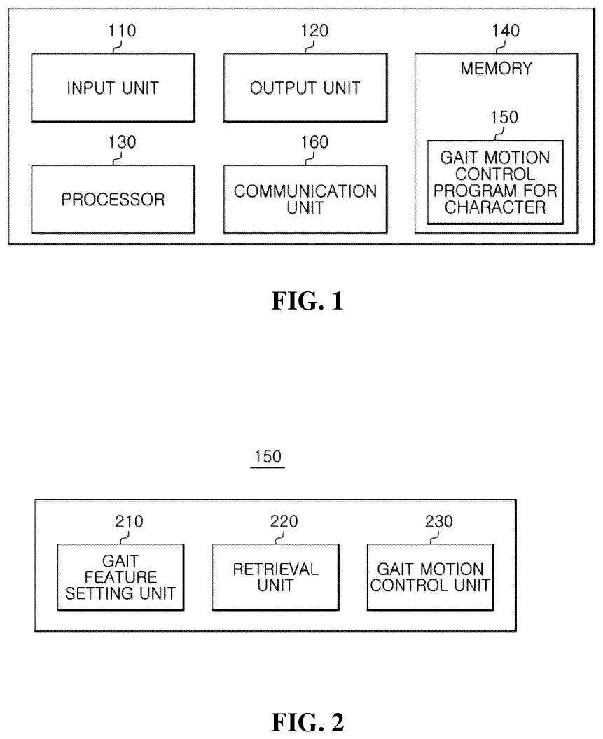

FIG. 1 is a block diagram exemplarily illustrating an apparatus for controlling a gait motion of a character according to an embodiment.

As shown in FIG. 1, an apparatus for controlling a gait motion of a character 100 may include an input unit 110, an output unit 120, a processor 130, a memory 140, and a communication unit 160. In one embodiment, the apparatus for controlling the gait motion of the character 100 may be implemented as a server that includes a gait motion control program for a character 150.

Hereinafter, for convenience of explanation, it is described by way of example that the apparatus for controlling the gait motion of the character 100 includes the input unit 110, the output unit 120, the processor 130, the memory 140, and the communication unit 160. However, the invention is not limited thereto. That is, each of the constituent units may be configured to operate outside the apparatus for controlling the gait motion of the character 100 and interact with the apparatus for controlling the gait motion of the character 100.

The input unit 110 may include a user interface for receiving commands, information, or the like used to control the apparatus for controlling the gait motion of the character 100. Additionally, the input unit 110 may include a hardware device (e.g., a keyboard, mouse, touchpad, etc.) capable of directly receiving commands, information, or the like used to control the apparatus for controlling the gait motion of the character 100.

In an embodiment, an input unit 110 may receive, as input, information required for a method for controlling a gait motion of a character from a user. Specifically, the user may input, through the input unit 110, information including motion capture data for the gait motion, spatial features for the gait motion, temporal features for the gait motion, a pose feature, information related to a style for the gait motion, or predetermined information for gait motion control.

The output unit 120 may provide, via an interface, visual information to a user, the visual information including motion capture data for the gait motion, spatial features for the gait motion, temporal features for the gait motion, pose features, information related to the style for the gait motion, predefined information for gait motion control, or results of the controlled gait motion of a character.

The processor 130 may generally control operations of the apparatus for controlling the gait motion of the character 100 in order to perform the present invention.

The processor 130 may load the gait motion control program for the character 150 and information required to execute the gait motion control program for the character 150 from the memory 140, and execute the gait motion control program for the character 150.

The processor 130 may control the apparatus for controlling the gait motion of the character 100 to store data received from an external device via the communication unit 160 in the memory 140. Further, the processor 130 may control the apparatus for controlling the gait motion of the character 100 to transmit and receive, via the communication unit 160, information including motion capture data for the gait motion, spatial features for the gait motion, temporal features for the gait motion, pose features, information related to the style for the gait motion, predefined information for gait motion control, or results of the controlled gait motion of a character, to and from an external device.

The processor 130 may include, but is not limited to, a microprocessor, a central processing unit (CPU), a graphic processing unit (GPU), a processor core, a multiprocessor, an application-specific integrated circuit (ASIC), a field programmable gate array (FPGA), or a microcontroller unit (MCU).

The memory 140 may store the gait motion control program for the character 150 and information necessary for execution of the gait motion control program for the character 150. The memory 140 may also store processing results generated by the processor 130.

The gait motion control program for the character 150 may refer to software including instructions programmed to perform the method according to the present invention.

The memory 140 may store motion capture data for the gait motion, spatial features for the gait motion, temporal features for the gait motion, pose features, information related to the style for the gait motion, predefined information for gait motion control, or results of the controlled gait motion of a character. In addition, the memory 140 may store information received from an external device via the communication unit 160.

The memory 140 may include, but is not limited to, computer-readable storage media such as magnetic media including hard disks, floppy disks, and magnetic tapes; optical media such as CD-ROMs and DVDs; magneto-optical media such as floptical disks; random access memories such as DRAM and SRAM; flash memory; or hardware devices specially configured to store and execute program instructions.

The communication unit 160 may be a wireless communication module configured to perform wireless communication using communication schemes such as CDMA, GSM, W-CDMA, TD-SCDMA, WiBro, LTE, EPC, 5G, wireless LAN, Wi-Fi, Bluetooth, Zigbee, Wi-Fi Direct (WFD), ultra wideband (UWB), infrared communication (IrDA), Bluetooth Low Energy (BLE), or near field communication (NFC), but is not limited thereto.

Furthermore, the information input and output via the input unit 110 and the output unit 120, the information stored in the memory 140, and the information transmitted and received via the communication unit 160 may include all information related to the present invention and are not limited to the above-described embodiments.

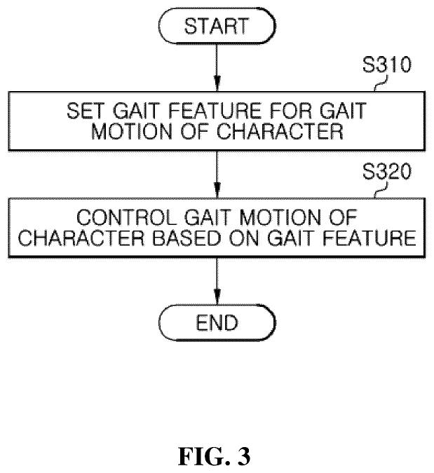

The function or operation of a gait motion control program for a character 150 will be described in detail with reference to FIG. 2.

FIG. 2 is a block diagram exemplarily illustrating the function of the gait motion control program for the character.

As illustrated in FIG. 2, the gait motion control program for the character 150 may include a gait feature setting unit 210, a retrieval unit 220, and a gait motion control unit 230. A gait feature setting unit 210, a retrieval unit 220, and a gait motion control unit 230 exemplify functional components of a gait motion control program for a character 150, and are not limited thereto.

In some embodiments, the respective functions of the gait feature setting unit 210, the retrieval unit 220, and the gait motion control unit 230 may be merged or separated, and may be implemented as a set of instructions included in at least one program.

The gait feature setting unit 210, the retrieval unit 220, and the gait motion control unit 230 may be implemented by a processor 130, and may refer to data processing devices embedded in hardware, each having a physically structured circuit for executing functions represented by code or instructions included in the gait motion control program for the character 150 stored in a memory 140.

The gait feature setting unit 210 may set a gait feature for the gait motion of the character. Here, the gait motion may also be referred to as locomotion. The locomotion may refer to a movement of a character that occurs when moving from one place to another in character animation. For example, the locomotion may refer to a movement of a character, such as walking, running, or jumping, etc. which is related to movement.

The gait feature may include a spatial feature and a temporal feature corresponding to the gait motion.

The spatial feature may be determined based on a contact surface between a left foot sole or a right foot sole of the character and a ground, which is formed on the ground according to walking of the character.

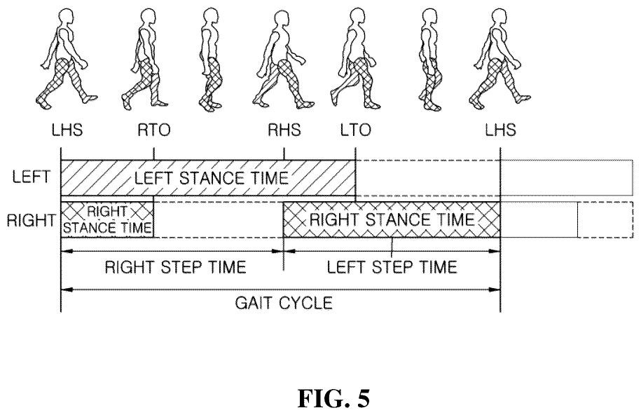

In an embodiment, the spatial feature may include at least one of a base width, a right step length, or a left step length. Specifically, based on a moving direction of the character, a first point positioned rearmost on an n-th (n is a natural number) contact surface between the left foot sole and the ground, a second point positioned rearmost on an m-th (m is a natural number) contact surface between the right foot sole and the ground, and a third point positioned rearmost on an (n+1)-th contact surface between the left foot sole and the ground may be determined. Here, the base width may be determined as a distance between the first point and the second point, based on a direction perpendicular to the moving direction, the right step length may be determined as a distance between the first point and the second point based on the moving direction, and the left step length may be determined as a distance between the second point and the third point based on the moving direction. A detailed description of the spatial features will be provided with reference to FIG. 4.

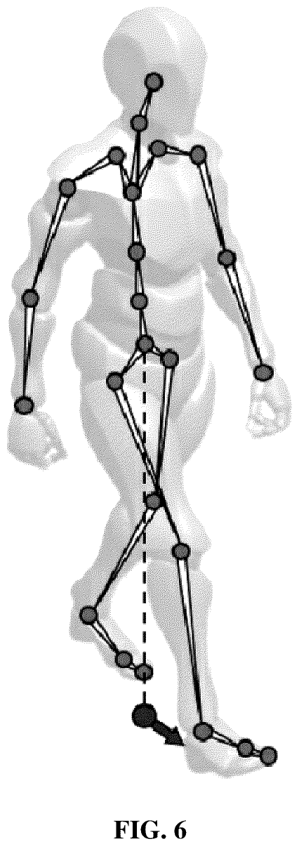

The temporal feature may include at least one of a right step time, a left step time, a right stance time, or a left stance time. The right step time may be determined as a time from a contact start point between a left foot sole of the character and the ground to a contact start point between a right foot sole of the character and the ground. The left step time may be determined as a time from a contact start point between the right foot sole and the ground to a contact start point between the left foot sole and the ground. The right stance time may be determined as a contact duration between the right foot sole and the ground. The left stance time may be determined as a contact duration between the left foot sole and the ground. A detailed description of the temporal features will be provided with reference to FIG. 5.

The retrieval unit 22 may retrieve a reference gait feature and a reference pose feature respectively corresponding to the gait feature and the pose feature, based on a plurality of reference gait features and a plurality of reference pose features extracted from a plurality of gait motions included in a pre-configured database.

The gait motion control unit 230 may control the gait motion of the character based on the gait feature.

The gait motion may be controlled by further considering a pose feature including positions and velocities of respective joints of the character.

In an embodiment, the pose feature may be calculated for each frame including the gait motion. Here, the gait feature may be identically set for each frame constituting a gait cycle corresponding to the gait motion.

The gait motion control unit 230 may control the gait motion of the character based on the reference gait feature and the reference pose feature retrieved by the retrieval unit 220. Here, the reference gait feature may be one of the plurality of reference gait features, which is most similar to the gait feature, selected by using a pre-configured algorithm. Also, the reference pose feature may be one of the plurality of reference pose features, which is most similar to the pose feature, selected by using the algorithm.

The gait motion control unit 230 may update a current gait motion of the character to a next gait motion based on the reference gait feature and the reference pose feature.

In an embodiment, as a difference in the pose feature between the current gait motion and the next gait motion exceeds a preset value, the gait motion control unit 230 may control the gait motion of the character by applying an intermediate gait motion obtained using a pre-configured interpolation algorithm between the current gait motion and the next gait motion. In another embodiment, as a difference in the pose feature between the current gait motion and the next gait motion exceeds a preset value, the gait motion control unit 230 may control the gait motion of the character by applying an intermediate gait motion obtained using an intermediate gait motion, to which a preset ratio is applied for the difference, between the current gait motion and the next gait motion.

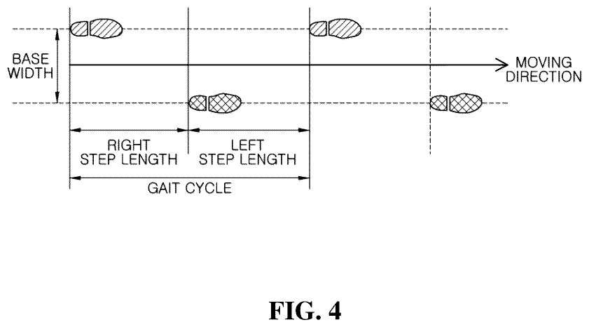

FIG. 3 is a flowchart exemplarily illustrating a method for controlling a gait motion of a character according to an embodiment. The method illustrated in FIG. 3 may be executed by the apparatus for controlling the gait motion of the character 100 shown in FIG. 1. In addition, the flowchart shown in FIG. 3 is merely illustrative, and the steps may be performed in an order different from that described in the flowchart according to embodiments. Furthermore, steps not shown in the flowchart may be additionally performed, or one or more of the steps described in the flowchart may be omitted.

As shown in FIG. 3, in accordance with an embodiment of a method for controlling a gait motion of a character performed by an apparatus for controlling a gait motion of a character, the method comprising: setting a gait feature corresponding to a gait motion of a character (S310), and controlling the gait motion of the character based on the gait feature (S320), wherein the gait feature includes a spatial feature and a temporal feature corresponding to the gait motion.

FIG. 4 is an exemplary diagram illustrating a spatial feature for the gait motion.

The spatial feature may be determined based on a contact surface between a left foot sole or a right foot sole of the character and the ground, which is formed on the ground according to the walking of the character. In an embodiment, the spatial feature may include at least one of a base width, a right step length, or a left step length. A base width, a right step length, and a left step length may be respectively determined every unit gait cycle, based on a moving direction of the character. Accordingly, the base width, the right step length, and the left step length may be identically set for each frame constituting the gait cycle.

Specifically, based on a moving direction of the character, a first point positioned rearmost on an n-th (n is a natural number) contact surface between the left foot sole and the ground, a second point positioned rearmost on an m-th (m is a natural number) contact surface between the right foot sole and the ground, and a third point positioned rearmost on an (n+1)-th contact surface between the left foot sole and the ground may be determined. Here, the base width may be determined as a distance between the first point and the second point, based on a direction perpendicular to the moving direction. The right step length may be determined as a distance between the first point and the second point based on the moving direction. The left step length may be determined as a distance between the second point and the third point based on the moving direction.

FIG. 5 is an exemplary diagram illustrating a temporal feature for the gait motion.

The temporal feature may include at least one of a right step time, a left step time, a right stance time, or a left stance time. A base width, a right step length, and a left step length may be respectively determined every unit gait cycle, based on a moving direction of the character. Accordingly, the base width, the right step length, and the left step length may be identically set for each frame constituting the gait cycle.

Specifically, the right step time may be determined as a time from a contact start point between a left foot sole of the character and the ground to a contact start point between a right foot sole of the character and the ground. The left step time may be determined as a time from a contact start point between the right foot sole and the ground to a contact start point between the left foot sole and the ground. The right stance time may be determined as a contact duration between the right foot sole and the ground. The left stance time may be determined as a contact duration between the left foot sole and the ground.

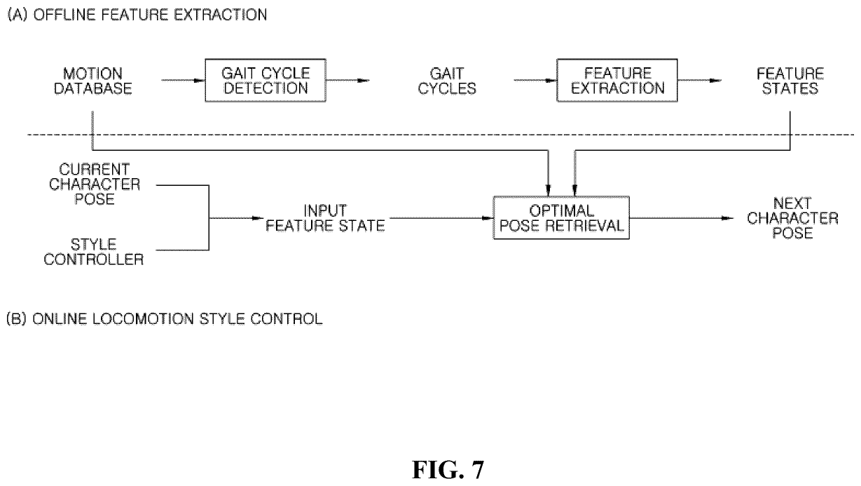

FIG. 6 is an exemplary diagram illustrating a pose feature, which is composed of positions and velocities of respective joints of the character.

With reference to FIG. 6, the pose feature may include information regarding positions and velocities of respective joints.

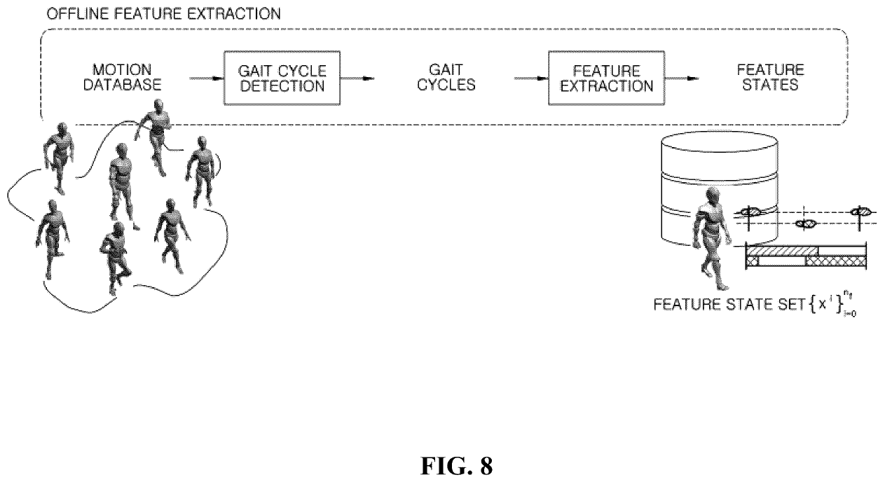

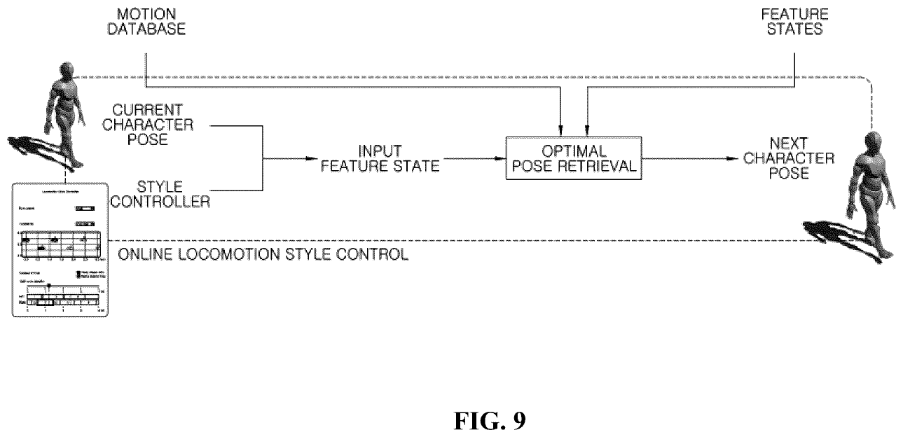

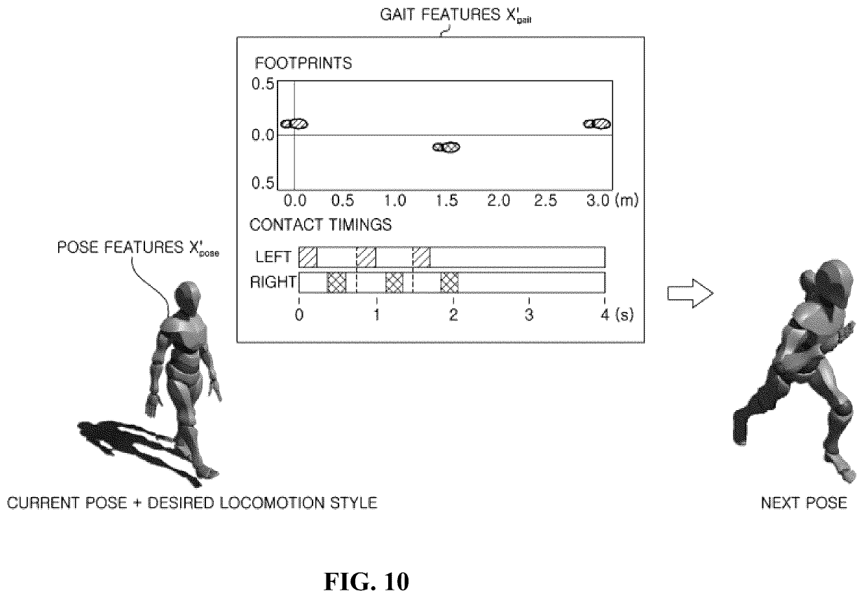

FIG. 7 is a flowchart illustrating a method for controlling a gait motion of a character according to an embodiment, FIG. 8 is an exemplary diagram specifically illustrating a gait feature extraction operation in the method for controlling a gait motion of a character according to the embodiment of FIG. 7, and FIG. 9 is an exemplary diagram specifically illustrating a gait motion control operation in the method for controlling a gait motion of a character according to the embodiment of FIG. 7.

With reference to FIG. 7, the method for controlling a gait motion of a character according to an embodiment may include an operation of extracting gait features in offline, and an operation of controlling gait motion, i.e., a locomotion style, in online.

Specifically, with reference to FIG. 8, the operation of extracting the gait features in offline may include steps of: constructing a motion database; detecting a gait cycle from motion capture data included in the motion database; and extracting gait features based on the motion capture data and the gait cycle. Here, the gait features may include a spatial feature and a temporal feature for the gait motion. In addition, gait features and pose features may be converted into feature states. In an offline stage, compressed pieces of information may be extracted for controlling a locomotion style in real time. First, in a motion database composed of a plurality of motion capture data, respective data related to gait motion may be divided into respective gait cycles, such that gait features and pose features may be calculated for each of the gait cycles. Based on the gait features and the pose features, feature states that may represent a style of the corresponding gait cycle may be determined and stored.

In addition, with reference to FIG. 9, in an operation of controlling a locomotion style in online, state features extracted in the offline stage and information provided in real time may be utilized so that a motion of the character may be controlled. The operation of controlling the locomotion style in online may include steps of: receiving, as input, current character pose information (current character pose) and a feature state from a style controller controlled by a user (input feature state); retrieving a most similar feature state by comparing the input feature state with all of the state features extracted in the offline stage (optimal pose retrieval); and loading a pose corresponding to the most similar feature state from the motion database to update the loaded pose as a next pose of the character (next character pose).

In an embodiment, a style of the gait motion or locomotion may include at least one of walking, running, jogging, jumping with two feet, hopping with one foot, or dragging.

Specifically, in order to control motions in real time, various motion data may be defined as the above-described spatial feature or temporal feature, and values for the corresponding features may be extracted and converted into the above-described feature state (x={xₚₒₛₑ,x_{gait}}). Such feature states may be assigned to each frame of the gait motion data.

First, a pose feature (xₚₒₛₑ={p,v}) may be expressed as values of respective joints of a rigged character such that a motion may be naturally continued by finding a pose most similar to a character being simulated in real-time style control, and may be composed of position values (p) and velocity values (v) of respective joints corresponding to a movement path of the character. The pose feature may be calculated for each frame.

Next, a gait feature (x_{gait}={s,t}) may include the above-described temporal feature (a right step time, a left step time, a right stance time, and a left stance time) and spatial feature (a base width, a right step length, and a left step length) so as to find a motion of a style corresponding to a user input, and values of the gait feature calculated for one gait cycle may be identically assigned to frames within the corresponding gait cycle.

Specifically, in the gait motion data, frames in which contact of each foot starts and ends may be acquired, and the gait feature may be calculated by dividing each foot contact into units of one gait cycle based on contact of one foot. The gait feature may be calculated by using contact positions and timings at the frames where the contact of each foot starts and ends, as described above. By using foot contact positions at frames where contact starts, s, which is a set of spatial features, may be acquired, and by obtaining step times from time values between the frames where foot contact starts, and stance times from time values between frames where foot contact starts and ends, t, which is a set of temporal features, may be acquired.

Through the above-described process, by repeating the process of returning a proper pose from a motion database by comparing feature states calculated in offline with values provided in real time from users, motions of a style desired by users may be controlled in real time.

In an embodiment, motion matching technology may be used for the above-described pose features and gait features so that real-time locomotion style control may be implemented.

The motion matching technology may define complex-dimensional motions as features of small dimension and may utilize these for motion exploration so as to explore motions in real time. In advance, for motions in the database, respective poses may be defined as features, which are small dimensional values, and in a simulation stage, features given in real time may be compared with the features in the database so that a most similar feature may be explored. While updating a pose corresponding to the explored feature as a next pose of a character, a gait motion of the character may be generated.

A pose feature may be extracted from the character being simulated in real time, and a gait feature may be extracted from a controller being controlled by a user, so that an input feature state may be extracted. The input feature state extracted in this way may be compared with feature states stored through a nearest neighbor algorithm, and a most similar feature state may be determined. The nearest neighbor algorithm may refer to an algorithm that operates in a manner of finding a nearest neighbor by measuring distances between data points. For example, the nearest neighbor algorithm may include K-Nearest Neighbors (K-NN) or Approximate Nearest Neighbor (ANN), but is not limited thereto. In an embodiment, the above-described similar feature state may be determined by using the following equation.

$${i}^{*} = {argmin}_{i} ( {a}_{pose} {ℒ}_{pose} + {a}_{dist} {ℒ}_{dist} + {a}_{time} {ℒ}_{time} ) \qquad Equation 1$$

Here, i* may refer to an explored frame, each [symbol] may be a mean squared error (MSE) corresponding to each of a pose feature xₚₒₛₑ, a spatial gait feature s, and a temporal gait feature t, and each α may refer to a predetermined parameter. The frame i* explored in this way may include a pose in a style that is most similar to a pose currently being simulated and most suitable to a user input. A pose corresponding to the frame explored in this way may be loaded from a motion database, and a next pose of the character may be updated.

In this case, when a gap between the pose to be updated and a pose being simulated is large, an interpolation algorithm may be used so as to naturally connect the poses. For example, such an interpolation algorithm may refer to inertialization blending. Through such an interpolation algorithm, a difference between a pose immediately before the transition and a pose to be transitioned may be acquired, and the interpolation may be realized by gradually reducing the difference value during a predetermined section and adding the reduced value to the pose to be updated. By repeating the above-described pose updating process every frame, a pose of the character may be updated, so that a user may control a motion of the character to a desired style in real time.

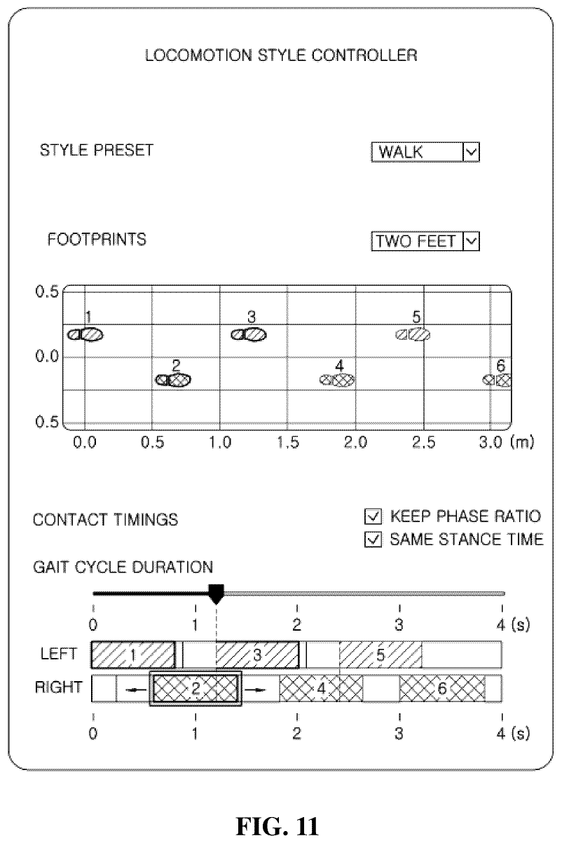

FIG. 10 is an exemplary diagram illustrating that a pose of a character is controlled based on a pose feature and a gait feature.

With reference to FIG. 10, it can be seen that a current walking pose is updated to a running pose, based on a current pose feature of the character and a gait feature input by a user.

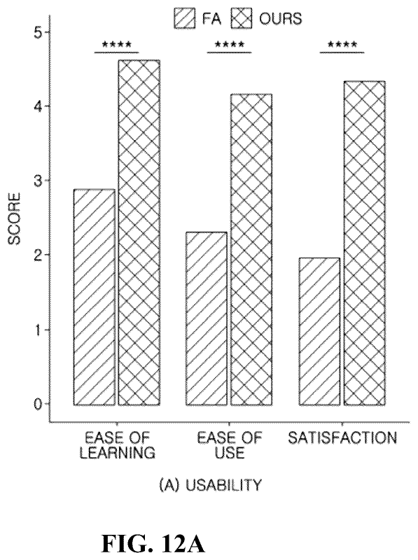

FIG. 11 is an exemplary diagram illustrating a gait motion control interface of a character according to an embodiment.

For the above-described gait feature, a graphical user interface (GUI) that allows a user to intuitively control the gait feature may be provided.

With reference to FIG. 11, the GUI may include a footprint pattern control function and a contact timing pattern control function, which may visually adjust spatial features.

In an embodiment, only parts corresponding to Footprints 1 to 3 in FIG. 11 may be controllable, and how the gait motion continues after Footprints 1 to 3 may be represented through parts corresponding to Footprints 4 to 6. The Footprints 4 to 6 may be controlled to be the same as the gait features corresponding to Footprints 1 to 3.

In a Footprints part of FIG. 11, a value s, which is a set of spatial features of the gait feature, may be controlled, and the footprints may be dragged to adjust the horizontal and vertical stride lengths. In addition, through a dropdown of Footprints, two feet and one foot may be selected, such that a transition to a hopping motion with one foot may be possible.

In a contact timings section of FIG. 11, a value t, which is a set of temporal features, may be controlled, and time values may be adjusted through sliders. For example, one cycle of gait may be controlled through the gait cycle duration slider, and respective sliders of Left and Right may be controlled so that stance times may be controlled. In addition, a right step time, which is a time when a next right foot contact occurs after a left foot contact, may be adjusted through a position of a second slider of Right, and a left step time may be calculated from a difference with the gait cycle duration.

For ease of motion control, the GUI may include checkboxes such as Keep phase ratio, which keeps ratios of other values constant even when the gait cycle duration is adjusted, or Same stance time, which controls stance times of the left and right feet to be the same.

In addition, in order to enhance usability by providing examples of representative styles, style presets (walk, jog, run, jump, drag, hop) may be provided.

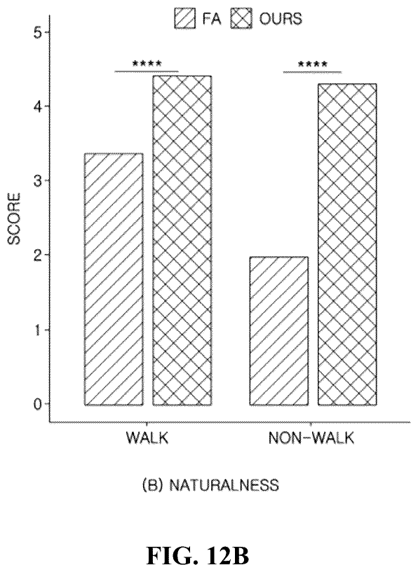

FIGS. 12A-12B are graphs showing evaluation results on a method for controlling a gait motion of a character according to an embodiment of the present disclosure.

In FIGS. 12A-12B, results of a comparative evaluation between the method for controlling a gait motion of a character (Ours) according to an embodiment of the present disclosure and a Footstep animation tool (FA) of 3DS MAX are illustrated. With reference to FIGS. 12A-12B, it can be seen that the method for controlling a gait motion of a character (Ours) according to an embodiment of the present disclosure achieved higher scores than FA in terms of usability of the interface, user satisfaction, and satisfaction with the generated motion.

As described above, according to an embodiment, the gait motion of the character may be intuitively controlled through spatiotemporal parameters for a foot contact pattern. Since a numerically quantifiable and objective control method is used, interpretation does not vary depending on a user who controls the gait motion of the character, and a style corresponding to the gait motion may be defined in a continuous space.

In addition, this may be commonly applied to humanoid characters including two feet.

In addition, by controlling motions of the character through a real-time motion control algorithm, motions desired by users may be implemented in real time. In this case, transitions between motions may be naturally connected through an interpolation algorithm.

In addition, by providing a visual interface of a controller capable of controlling a gait pattern, a user may intuitively and easily control the gait motion of the character through such an interface.

In addition, an embodiment of the present disclosure may be utilized for real-time motion control simulation, and may also be utilized as a motion explorer application. That is, by using gait feature parameters, rather than a conventional text classification method, more accurate gait motion representation becomes possible, and different motions may be explored in real time according to changes in the parameters, and the exploration may be easily performed by visually presenting the motions. In addition, through the utilization of a motion control algorithm widely used in games, an embodiment of the present disclosure may be easily integrated into existing character control applications.

The embodiments of the present invention described above may be implemented in various ways. For example, the embodiments of the present invention may be implemented by hardware, firmware, software, or a combination thereof.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for controlling a gait motion of a character performed by an apparatus for controlling a gait motion of a character, the method comprising:
setting a gait feature corresponding to a gait motion of a character; and
controlling the gait motion of the character based on the gait feature,
wherein the gait feature includes a spatial feature and a temporal feature corresponding to the gait motion.

2. The method of claim 1, wherein the spatial feature is determined based on a contact surface between a left foot sole or a right foot sole of the character and a ground, which is formed on the ground according to walking of the character.

3. The method of claim 2, wherein the spatial feature includes at least one of a base width, a right step length, or a left step length, and
wherein, based on a moving direction of the character, corresponding to a first point positioned rearmost on an n-th (n is a natural number) contact surface between the left foot sole and the ground, a second point positioned rearmost on an m-th (m is a natural number) contact surface between the right foot sole and the ground, and a third point positioned rearmost on an (n+1)-th contact surface between the left foot sole and the ground,
the base width is determined as a distance between the first point and the second point, based on a direction perpendicular to the moving direction,
the right step length is determined as a distance between the first point and the second point based on the moving direction, and
the left step length is determined as a distance between the second point and the third point based on the moving direction.

4. The method of claim 1, wherein the temporal feature includes at least one of a right step time, a left step time, a right stance time, or a left stance time,
the right step time is determined as a time from a contact start point between a left foot sole of the character and the ground to a contact start point between a right foot sole of the character and the ground,
the left step time is determined as a time from a contact start point between the right foot sole and the ground to a contact start point between the left foot sole and the ground,
the right stance time is determined as a contact duration between the right foot sole and the ground, and
the left stance time is determined as a contact duration between the left foot sole and the ground.

5. The method of claim 1, wherein the gait motion is controlled by further considering a pose feature including positions and velocities of respective joints of the character.

6. The method of claim 5, wherein the pose feature is calculated for each frame including the gait motion, and the gait feature is identically set for each frame constituting a gait cycle corresponding to the gait motion.

7. The method of claim 5, further comprising:
retrieving a reference gait feature and a reference pose feature respectively corresponding to the gait feature and the pose feature, based on a plurality of reference gait features and a plurality of reference pose features extracted from a plurality of gait motions included in a pre-configured database,
wherein in the controlling the gait motion, the gait motion of the character is controlled based on the reference gait feature and the reference pose feature.

8. The method of claim 7, wherein the reference gait feature is one of the plurality of reference gait features, which is most similar to the gait feature, selected by using a pre-configured algorithm, and the reference pose feature is one of the plurality of reference pose features, which is most similar to the pose feature, selected by using the algorithm.

9. The method of claim 8, wherein in the controlling the gait motion, a current gait motion of the character is updated to a next gait motion based on the reference gait feature and the reference pose feature.

10. The method of claim 9, wherein in the controlling the gait motion, as a difference in the pose feature between the current gait motion and the next gait motion exceeds a preset value, an intermediate gait motion acquired by using a pre-configured interpolation algorithm is applied between the current gait motion and the next gait motion to control the gait motion.

11. The method of claim 9, wherein in the controlling the gait motion, as a difference in the pose feature between the current gait motion and the next gait motion exceeds a preset value, an intermediate gait motion, to which a preset ratio is applied for the difference, is applied between the current gait motion and the next gait motion to control the gait motion.

12. An apparatus for controlling a gait motion of a character, the apparatus comprising:
a memory storing at least one instruction; and
a processor executing the at least one instruction stored in the memory,
wherein the at least one instruction, when executed by the processor, causes the processor to:
set a gait feature corresponding to a gait motion of a character; and
control the gait motion of the character based on the gait feature,
wherein the gait feature includes a spatial feature and a temporal feature corresponding to the gait motion.

13. The apparatus of claim 12, wherein the spatial feature is determined based on a contact surface between a left foot sole or a right foot sole of the character and a ground, which is formed on the ground according to walking of the character.

14. The apparatus of claim 13, wherein the spatial feature includes at least one of a base width, a right step length, or a left step length, and
wherein, based on a moving direction of the character, corresponding to a first point positioned rearmost on an n-th (n is a natural number) contact surface between the left foot sole and the ground, a second point positioned rearmost on an m-th (m is a natural number) contact surface between the right foot sole and the ground, and a third point positioned rearmost on an (n+1)-th contact surface between the left foot sole and the ground,
the base width is determined as a distance between the first point and the second point, based on a direction perpendicular to the moving direction,
the right step length is determined as a distance between the first point and the second point based on the moving direction, and
the left step length is determined as a distance between the second point and the third point based on the moving direction.

15. The apparatus of claim 12, wherein the temporal feature includes at least one of a right step time, a left step time, a right stance time, or a left stance time,
the right step time is determined as a time from a contact start point between a left foot sole of the character and the ground to a contact start point between a right foot sole of the character and the ground,
the left step time is determined as a time from a contact start point between the right foot sole and the ground to a contact start point between the left foot sole and the ground,
the right stance time is determined as a contact duration between the right foot sole and the ground, and
the left stance time is determined as a contact duration between the left foot sole and the ground.

16. The apparatus of claim 12, wherein the gait motion is controlled by further considering a pose feature including positions and velocities of respective joints of the character.

17. The apparatus of claim 16, wherein the pose feature is calculated for each frame including the gait motion, and the gait feature is identically set for each frame constituting a gait cycle corresponding to the gait motion.

18. The apparatus of claim 16, wherein the at least one instruction, when executed by the processor, causes the processor to further:
retrieve a reference gait feature and a reference pose feature respectively corresponding to the gait feature and the pose feature, based on a plurality of reference gait features and a plurality of reference pose features extracted from a plurality of gait motions included in a pre-configured database, and
control the gait motion of the character based on the reference gait feature and the reference pose feature.

19. The apparatus of claim 18, wherein the reference gait feature is one of the plurality of reference gait features, which is most similar to the gait feature, selected by using a pre-configured algorithm, and the reference pose feature is one of the plurality of reference pose features, which is most similar to the pose feature, selected by using the algorithm.

20. A non-transitory computer-readable storage medium storing computer-executable instructions, the computer executable instructions, when executed by a processor, cause the processor to perform a method, the method comprising:
setting a gait feature corresponding to a gait motion of a character; and
controlling the gait motion of the character based on the gait feature,
wherein the gait feature includes a spatial feature and a temporal feature corresponding to the gait motion.
